(19) United States
(12) Patent Application Publication
(10) Pub. No.: US 2003/0159813 A1
(43) Pub. Date: Aug. 28, 2003

(54) Heat exchanger manifold and method of assembly

(75) Inventor: Antonio Baldantoni, Ann Arbor, MI (US)

Correspondence Address: HARTMAN & HARTMAN, P.C., 552 EAST 700 NORTH, VALPARAISO, IN, 46383, US

(73) Assignee: Norsk Hydro, Oslo (NO)

(21) Appl. No.: 09/683,894

(22) Filed: Feb. 28, 2002

(51) Int. Cl. B23P 15/26; B21D 51/38; F28D 7/10

(52) U.S. Cl. 165/140; 29/890.052

(57) ABSTRACT

A heat exchanger manifold (10) that comprises multiple members (20,22) and makes use of a simple snap-fit assembly technique to secure the members (2022) together. The manifold (10) includes first and second members (20,22), each of which comprises a rib (26) and first and second extensions (24) separated by the rib (26) and laterally extending from the rib (26). The extensions (24) of each member laterally terminate in edges (42) that abut the edges (42) of the other member. The ribs (26) of the members have complementary snap-fit means (28,30) for securing the first and second members (20,22) together. During assembly of the members (20,22), the snap-fit means (28,30) are aligned with each other and then engaged by applying a force on exterior surfaces of the manifold members (20,22), preferably opposite the ribs (26) to reduce the risk of damage to the extensions (24).

### BACKGROUND OF INVENTION

1. Field of the Invention

The present invention generally relates to heat exchangers, such as those of the type used as condensers in automobile air-conditioning systems. More particularly, this invention relates to a heat exchanger manifold assembly whose components can be assembled and secured to each other by snap-fit features to allow for handling of the assembly prior to being permanently joined, such as by brazing, soldering, welding or adhesive bonding.

2. Description of the Related Art

Heat exchangers are employed within the automotive industry as condensers and evaporators for use in air conditioning systems, radiators for cooling engine coolant, and heater cores for internal climate control. In order to efficiently maximize the amount of surface area available for transferring heat between the environment and a fluid flowing through the heat exchanger, heat exchanger designs are typically of a tube-and-fin type in which numerous tubes thermally communicate with high surface area fins. The fins enhance the ability of the heat exchanger to transfer heat from the fluid to the environment, or vice versa. For example, heat exchangers used in the automotive industry as air conditioner condensers serve to condense a vaporized refrigerant by transferring heat from the refrigerant to the air forced over the external surfaces of the condenser.

One type of heat exchanger used in the automotive industry is constructed of a number of parallel cooling tubes that are joined to and between a pair of manifolds, creating a parallel flow arrangement. An internal passage within each manifold defines a reservoir that is in fluidic communication with the tubes through tube ports, e.g., holes or slots, formed in the manifold. One or both manifolds include one or more inlet and outlet ports through which a coolant enters and exits the heat exchanger. To promote thermal efficiency, such heat exchangers have typically been constructed by soldering or brazing the tubes to their respective ports. Finally, fins are provided in the form of panels having apertures through which the tubes are inserted, or in the form of sinusoidal centers that can be positioned between adjacent pairs of oblong or Aflat@ tubes. A notable flat tube design is known as a microtube, whose oval shape accommodates a row of parallel passages separated by walls formed integrally with the microtube, such that heat transfer efficiency is enhanced by increasing the surface area in contact with the coolant.

Various manifold constructions have been suggested. While manifolds with multiple internal passages are known that allow for the use of more than one coolant medium by a heat exchanger, the more typical manifold configuration is of a single passage fluidically connected to all of the cooling tubes. Tubular manifolds with a circular cross-section have typically been preferred for use in high pressure applications, such as condensers. However, tubular manifolds are relatively difficult to punch or pierce in order to form tube ports. Two-piece manifolds that comprise a tank and header plate overcome this problem by locating the tube ports in the header plate, which can be relatively flat to facilitate piercing or punching. The header plate is then mechanically or metallurgically secured to the tank to define a passage that fluidically communicates with the tube ports. However, a drawback to a two-piece manifold construction is the difficulty of handling the manifold assembly, particularly if the manifold is part of a heat exchanger that is to be metallurgically joined, such as by brazing or soldering. Solutions to this problem include forming the tank and header plate with complementary features that are able to at least temporarily secure the tank and header plate together until the permanent joining step is performed. In U.S. Pat. No. 5,107,926 to Calleson, a header plate is secured to a tank with longitudinal flanges that are crimped to engage the lateral edges of the header plate. The requirement for an intermediate forming step is avoided in U.S. Pat. No. 5,127,466 to Ando, which discloses a tank that is assembled with a header plate by press-fitting the lateral edges of the header plate into longitudinal grooves that run the length of the tank. However, considerable force may be required to successfully press-fit the header plate into the grooves, raising the risk of damage to the header plate and tank. A two-piece tubular manifold is disclosed in U.S. Pat. No. 5,944,096 to Hubert, in which U-shaped manifold members are assembled by snap-fitting the members together as a result of an interference fit between the marginal regions of the members. However, careful alignment of the marginal regions along their entire lengths is necessary to successfully assemble the manifold members.

While the above prior art facilitate the handling of a multiple-piece manifold, further improvements would be desirable, particular in terms of reducing the assembly steps, relaxing alignment tolerances, and compatibility with other manifold configurations.

### SUMMARY OF INVENTION

The present invention provides a heat exchanger manifold that comprises multiple members and makes use of a simple snap-fit action to secure the members together. The manifold and its method of assembly are particular adapted for defining multiple internal passages within the manifold, with adjacent passages separated by a partition that may extend along the longitudinal length of the manifold.

The manifold generally includes first and second members, each of which comprises a rib and first and second extensions. The extensions are separated by the rib and laterally extend from the rib, and have laterally terminating edges. The ribs of the manifold members have complementary snap-fit features for securing the first and second members together. When the members of the manifold are secured together, the snap-fit features are located within the interior of the manifold, and the extensions largely define the internal passages of the manifold. To assemble the manifold members, their respective snap-fit features are aligned with each other and then engaged by applying a force on an exterior surface of the manifold members, such as opposite the ribs to reduce the risk of damage to the extensions. After assembly, the manifold can be handled with minimal risk of its members coming apart. Either of the members can be formed to have tube ports, into which cooling tubes are inserted. The entire tube and manifold assembly can then undergo brazing, soldering or any other type of joining operation to join the manifold members together at the edges of the extensions, and preferably also along the ribs.

From the above, it can be seen that the manifold assembly of this invention is able to significantly facilitate the assembling and subsequent handling of a multiple-piece manifold. The assembly method is characterized by an uncomplicated snap-fit assembly technique, in which a single set of complementary snap-fit features can be used. The snap-fit features are located on the manifold members so as to securely connect the members together while reducing the risk of damage to the features and to the manifold members during assembly. When joined, the ribs are able to define separate passages within the manifold assembly, which if so desired can be used to handle different coolants within the heat exchanger in which the manifold is used.

Other objects and advantages of this invention will be better appreciated from the following detailed description.

### BRIEF DESCRIPTION OF DRAWINGS

FIGS. 1 and 2 are plan and cross-sectional views, respectively, of a heat exchanger manifold in accordance with this invention.

FIG. 3 is a detailed view of a portion of the manifold of FIGS. 1 and 2.

FIG. 4 is a partial perspective view of the manifold of FIGS. 1 and 2 assembled within a heat exchanger.

### DETAILED DESCRIPTION

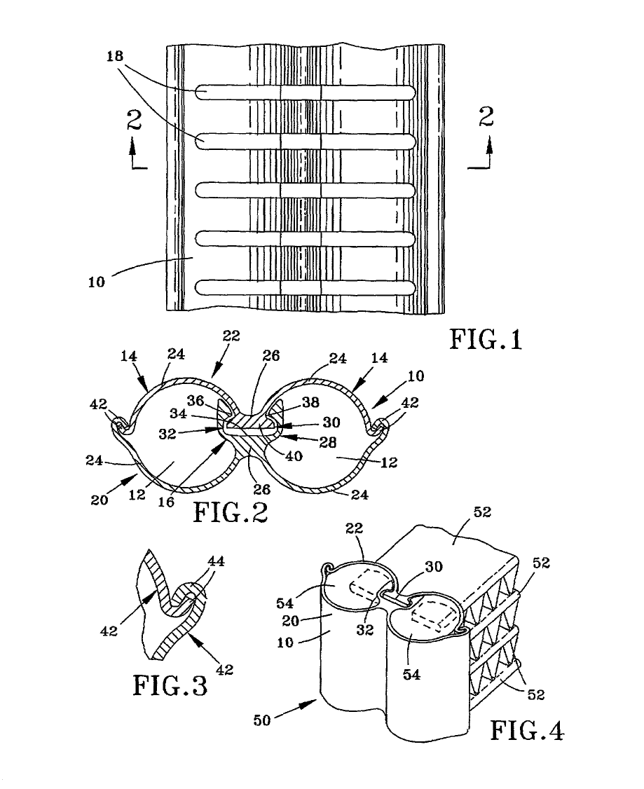

A manifold 10 configured in accordance with this invention is represented in FIGS. 1 and 2. The manifold 10 is depicted as having two parallel internal chambers or passages 12 defined by two tubular portions 14 separated by a partition 16, though more than two passages 12 could be present. The passages 12 and partition 16 preferably extend the entire length of the manifold 10. In FIG. 1, the manifold 10 can be seen as having slots 18, each of which is sized to receive one end of a cooling tube (52 in FIG. 4). Each slot 18 extends through the walls of the tubular portions 14 to fluidically connect to both of the passages 12. The manifold 10 is shown in FIG. 4 assembled in a heat exchanger 50, more particularly a tube-and-center heat exchanger of a type used as a condenser in an automotive air-conditioning system, though other applications are within the scope of the invention. The tubes 52 are shown as being geometrically and hydraulically in parallel with each other, though a serpentine tube configuration could also be used. A suitable fluid, such as for example a refrigerant, flows through the tubes 52 between the manifold 10 and a second manifold (not shown), which may have a different configuration than the manifold 10.

The manifold 10 is shown as being formed by two members 20 and 22, each defining roughly half of the manifold 10. The tubular portions 14 of the manifold 10 are defined by extensions 24 that extend from a midportion of each member 20 and 22, while the partition 16 is defined by ribs 26 located at the midportion of each member 20 and 22 so as to be between the extensions 24. As seen in FIG. 2, the manifold 10 is an assembly of the members 20 and 22, which are connected along the longitudinal axis of the manifold 10 by complementary snap-fit features 28 and 30 defined at the ribs 26 of the members 20 and 22. As a result of the snap-fit features 28 and 30, the members 20 and 22 are capable of being assembled and held together for handling, such as until the members 20 and 22 are brazed, soldered, welded or adhesively bonded together to form the manifold 10.

The feature 28 defined in the rib 26 portion of the member 20 includes a longitudinal recess or groove 32, with an interior region 34 and a distal neck region 36 whose lateral width that is less than that of the interior region 34. The feature 30 defined by the rib 26 of the other member 22 has a generally T-shaped cross-section that includes a neck region 38 and a distal head region 40. The distal head region 40 can be seen to have a lateral width that is greater than that of the neck region 38. Furthermore, the features 28 and 30 are complementary, in that the lateral width of the distal head region 40 is less than the lateral width of the interior region 34 of the groove 32, but greater than the lateral width of the distal neck region 34 of the groove 32 so that the distal head region 40 has a snap-fit with the groove 32. Accordingly, assembly of the members 20 and 22 entails aligning the ribs 26 of the members 20 and 22, and then applying a force to the members 20 and 22, preferably in the vicinity of their surfaces opposite their ribs 26, to force the distal head region 40 through the distal neck region 34 and into the interior region 34 of the groove 32. While the snap-fit features 28 and 30 are shown as having the particular configurations described above, it is foreseeable that a variety of other configurations could be used. The underlying requirement for the features 28 and 30 is that they are complementary and an interference exists between the features 28 and 30 during (and possibly after) the assembly process, such that the interference resists separation of the members 20 and 22. In a preferred embodiment, the distal head region 40 is not continuous along the length of the snap-fit feature 30 so as to reduce the force required to snap-fit the members 20 and 22 together.

As seen in FIG. 2, opposing edges 42 of the extensions 24 contact each other to enclose the passages 12. The edges 42 of the extensions 24 are preferably equipped with complementary snap-fit features 44, as shown in detail in FIG. 3. These features 44 hold the edges 42 of the extensions 24 together, facilitating sealing of the edges 42 by brazing, soldering, etc. While the features 44 are shown as having hook or J-shaped cross-sections, other configurations are possible and within the scope of this invention. Alternatively, the features 44 could be omitted, such that the members 20 and 22 are initially secured together only by the snap-fit features 28 and 30 on the ribs 26, in which case the extensions 24 are preferably formed so that their edges 42 firmly contact each other to eliminate gaps therebetween.

The heat exchanger 50 shown in FIG. 4 has a monolithic construction, with end plugs 54 used to close the ends of the passages 12 of the manifold 10. The entire heat exchanger 50 is preferably brazed or soldered together in a single operation in order to facilitate its manufacture. All of the components described above are preferably formed from a suitable aluminum alloy, though other alloys could be used. To further facilitate assembly and joining, some or all of the components of the heat exchange 50 may be formed from a clad aluminum alloy. For example, the components can be formed to have an aluminum alloy core clad with a suitable braze alloy, such as an aluminum-silicon eutectic brazing alloy or a zinc-aluminum alloy for soldering operations. As a result, the cladding has a lower melting temperature than the core material, and can therefore flow to form brazements or solder joints at temperatures that will not damage the heat exchanger 50.

The members 20 and 22 are also preferably joined by brazing or soldering, in which case a cladding (not shown) may be provided on one or both members 20 and 22 to provide the necessary braze or solder material. The cladding can be provided on an interior surface of one or both members 20 and 22, so that during brazing or soldering the cladding material is able to melt and flow into the joints between the ribs 26 and between the abutting edges 42 of the extensions 24. Upon cooling, the cladding material forms fluid-tight joints that metallurgically bond the ribs 26 and the edges 42 of the extensions 24.

While the invention has been described in terms of a preferred embodiment, it is apparent that other forms could be adopted by one skilled in the art. For example, materials, processes and procedures other than those noted above could be adopted, and the manifold and heat exchanger could be modified considerably from that shown in the Figures in order to be suitable for a variety of applications. Accordingly, the scope of the invention is to be limited only by the following claims.

1. A heat exchanger manifold comprising:
first and second members assemblable to form the manifold, each of the first and second members comprising a rib and first and second extensions separated by the rib and laterally extending from the rib, the first and second extensions of each of the first and second members laterally terminating in first and second edges, respectively; and
complementary snap-fit means disposed at the ribs of the first and second members for securing the first and second members together.

2. A heat exchanger manifold according to claim 1, wherein the snap-fit means comprises:
a neck region and a distal head region on the rib of the first member, the distal head region having a lateral width that is greater than the neck region; and
a recess in the rib of the second member, the recess having an interior region and a distal neck region with a lateral width that is less than the interior region;
the lateral width of the distal head region of the first member being less than the lateral width of the interior region of the recess in the second member but greater than the lateral width of the distal neck region of the recess so that the distal head region of the first member has a snap-fit with the recess of the second member.

3. A heat exchanger manifold according to claim 1, further comprising
complementary snap-fit means disposed on the first edges of the first and second members for securing the first extensions of the first and second members together, and complementary snap-fit means disposed on the second edges of the first and second members for securing the second extensions of the first and second members together.

4. A heat exchanger manifold according to claim 3, wherein each of the complementary snap-fit means disposed on the first and second edges of the first and second members comprises a J-shaped feature.

5. A heat exchanger manifold according to claim 1, wherein the first and second members are assembled to form the manifold, and the ribs of the first and second members are secured together by the snap-fit means to define a partition within the manifold that defines a pair of chambers within the manifold that are separated by the partition.

6. A heat exchanger manifold according to claim 5, wherein the first and second edges of the first member contact the first and second edges of the second member such that the chambers are enclosed by the partition formed by the ribs and the first and second extensions of the first and second members.

7. A heat exchanger manifold according to claim 6, wherein each of the chambers has a circular cross-section.

8. A heat exchanger manifold according to claim 1, wherein the first and second members are assembled to form the manifold, the manifold further comprising a material bonding the ribs of the first and second members together and bonding the first and second edges of the first member to the first and second edges of the second member, respectively.

9. A heat exchanger manifold according to claim 1, further comprising ports defined in one of the first and second members and tubes received in the ports for carrying a fluid to and from the manifold.

10. A heat exchanger having a pair of manifolds and tubes fluidically connected to each of the manifolds for carrying a fluid to and from the manifolds, at least one of the manifolds comprising:
first and second members assembled together to form the manifold, each of the first and second members comprising a rib and first and second extensions separated by the rib and laterally extending from the rib, the first and second extensions of each of the first and second members laterally terminating in first and second edges, respectively;
a recess defined in the rib of the second member, the recess having an interior region and a distal neck region with a lateral width that is less than the interior region; and
a neck region and a distal head region defined by the rib of the first member, the distal head region having a lateral width that is greater than the neck region;
wherein the lateral width of the distal head region is less than the lateral width of the interior region of the recess in the second member but greater than the lateral width of the distal neck region of the recess so that the distal head region of the first member has a snap-fit with the recess of the second member that secures the first and second members together, and the ribs of the first and second members together define a partition within the manifold that defines a pair of chambers within the manifold that are separated by the partition.

11. A heat exchanger according to claim 10, wherein the at least one manifold further comprises complementary snap-fit means disposed on the first edges of the first and second members for securing the first extensions the first and second members together, and complementary snap-fit means disposed on the second edges of the first and second members for securing second extensions of the first and second members together.

12. A heat exchanger according to claim 11, wherein each of the complementary snap-fit means disposed on the first and second edges of the first and second members comprises a J-shaped feature.

13. A heat exchanger according to claim 10, wherein the first and second edges of the first member contact the first and second edges of the second member such that the chambers are enclosed by the partition formed by the ribs and the first and second extensions of the first and second members.

14. A heat exchanger according to claim 10, wherein each of the chambers has a circular cross-section.

15. A heat exchanger according to claim 10, wherein the at least one manifold further comprises a material metallurgically bonding the ribs of the first and second members together and metallurgically bonding the first and second edges of the first member to the first and second edges of the second member, respectively.

16. A method of assembling a heat exchanger manifold, the method comprising the steps of:
providing first and second members that are assemblable to form the manifold, each of the first and second members comprising a rib and first and second extensions separated by the rib and laterally extending from the rib, the first and second extensions of each of the first and second members laterally terminating in first and second edges, respectively, the ribs of the first and second members having complementary snap-fit means for securing the first and second members together; and
assembling the first and second members by engaging the snap-fit means of the first and second members.

17. A method according to claim 16, wherein:
the snap-fit means comprises a neck region and a distal head region on the rib of the first member and a recess in the rib of the second member, the distal head region of the first member having a lateral width that is greater than the neck region of the first member; the recess of the second member having an interior region and a distal neck region with a lateral width that is less than the interior region, the lateral width of the distal head region of the first member being less than the lateral width of the interior region of the recess in the second member but greater than the lateral width of the distal neck region of the recess; and
the assembling step comprises inserting the distal head region of the first member through the distal neck region of the recess and into the interior region of the recess.

18. A method according to claim 16, wherein the assembling step further comprises applying a force on exterior surfaces of the first and second members opposite their respective ribs.

19. A method according to claim 16, wherein the assembling step further comprises securing the first extensions together with complementary snap-fit means disposed on the first edges of the first extensions, and securing the second extensions together with complementary snap-fit means disposed on the second edges of the second extensions.

20. A method according to claim 16, wherein as a result of the assembling step the ribs of the first and second members define a partition that defines a pair of chambers within the manifold that are separated by the partition.

21. A method according to claim 20, wherein as a result of the assembling step the first and second edges of the first member contact the first and second edges of the second member such that the chambers are enclosed by the partition formed by the ribs and the first and second extensions of the first and second members.

22. A method according to claim 16, further comprising the step of bonding the ribs of the first and second members together and bonding the first and second edges of the first member to the first and second edges of the second member, respectively.

23. A method of assembling a heat exchanger comprising a pair of manifolds, the method comprising the steps of:
providing at least one of the manifolds to have first and second members, each of the first and second members comprising a rib and first and second extensions separated by the rib and laterally extending from the rib, the first and second extensions of each of the first and second members laterally terminating in first and second edges, respectively, the rib of the second member having a recess with an interior region and a distal neck region having a lateral width that is less than the interior region, the rib of the first member having a neck region and a distal head region with a lateral width that is greater than the neck region, the lateral width of the distal head region being less than the lateral width of the interior region of the recess in the second member but greater than the lateral width of the distal neck region of the recess so that the distal head region of the first member has a snap-fit with the recess of the second member;
assembling the first and second members by inserting the distal head region of the first member through the distal neck region of the recess and into the interior region of the recess, the ribs of the first and second members together defining a partition within the manifold that defines a pair of chambers within the manifold that are separated by the partition; and
fluidically connecting tubes to each of the manifolds for carrying a fluid to and from the manifolds.

24. A method according to claim 23, wherein the assembling step further comprises applying a force on exterior surfaces of the first and second members opposite their respective ribs.

25. A method according to claim 23, wherein the assembling step further comprises securing the first extensions together with complementary snap-fit means disposed on the first edges of the first extensions, and securing the second extensions together with complementary snap-fit means disposed on the second edges of the second extensions.

26. A method according to claim 23, wherein as a result of the assembling step the first and second edges of the first member contact the first and second edges of the second member such that the chambers are enclosed by the partition formed by the ribs and the first and second extensions of the first and second members.

27. A method according to claim 23, further comprising the step of metallurgically bonding the ribs of the first and second members together and metallurgically bonding the first and second edges of the first member to the first and second edges of the second member, respectively.
